(19) United States
(12) Patent Application Publication
(10) Pub. No.: US 2008/0270206 A1
(43) Pub. Date: Oct. 30, 2008

(54) Method for detecting suspicious transactions

(75) Inventor: Alben Joseph Gillum, Hanover, MD (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: United States Postal Service

(21) Appl. No.: 12/010,152

(22) Filed: Jan. 22, 2008

Related U.S. Application Data
(63) Continuation of application No. 10/661,449, filed on Sep. 13, 2003.

(51) Int. Cl. G06Q 10/00; G06Q 40/00

(52) U.S. Cl. 705/7; 705/30

(57) ABSTRACT

A method is described for detecting suspicious financial transactions, especially those as identified by the federal Bank Security Act. An automated means of processing financial data to identify suspicious transactions is described as well as a means to assign and manage a manual review of transactions to employees through an automated method, and to enable distribution of review information through and automated technique. The present invention also provides a method to monitor and enforce employee compliance with federal anti-money laundering laws and organization policy. Furthermore, the present invention provides a method to automatically monitor financial transactions with a collection of specified criteria and send immediate real-time feedback and disabling (lockout) information to terminals where such transactions originate.

### CROSS REFERENCES TO RELATED APPLICATIONS

This application claims the full benefit and priority of U.S. Provisional Application Ser. No. 60/410,867, filed on Sep. 13, 2002, the disclosure of which is fully incorporated herein for all purposes.

### STATEMENT REGARDING FEDERALLY SPONSORED RESEARCH OR DEVELOPMENT

Not applicable.

### BACKGROUND OF THE INVENTION

1. Field of the Invention

The present invention relates to a method of detecting suspicious financial transactions for the purpose of complying with the Bank Secrecy Act and USA PATRIOT Act. More particularly the invention assists in the detection and reporting of illegal money laundering schemes.

2. Description of the Related Art

As computer networks and electronic funds transfers became more readily available to the general public, organized crime and racketeering organizations have become increasingly sophisticated in their efforts to conceal money laundering operations. At times, even low-technology options such as the use of money orders has been used in an attempt to thwart the efforts of law enforcement in detecting transfer of funds that originated from illicit sources. For law enforcement operations to effectively inhibit the laundering and transfer of money, they require assistance from private organizations and government agencies to provide information relating to suspicious financial transactions. Congress has responded to this need by passing legislation that now affects nearly every financial organization.

The initial statutes of what would later become known as the Bank Secrecy Act (BSA or Act), a set of laws designed to detect and deter money laundering, were enacted in 1970. In the early 1990's the BSA was modified several times and was codified in Title 31, U.S. Code, Sections 5311-5355. In one general aspect, the BSA requires financial institutions to record and report certain transactions that have a high degree of usefulness in criminal, tax, or regulatory investigations or proceedings. The BSA was further amended by the USA PATRIOT Act of 2001. The purpose and scope of the BSA was expanded to include “the conduct of intelligence or counterintelligence activities, including analysis, to protect against international terrorism.” Since its enactment in 1970, the BSA was focused almost exclusively on domestic affairs. The amendments in the USA PATRIOT Act expand the scope of the BSA to the international arena, specifically in the field of intelligence.

The BSA now requires financial institutions to obtain certain identifying information from individuals who conduct money transactions for $3,000 or more. Further the act requires financial institutions to report identifying information to the United States Department of the Treasury (Treasury Department) on Form 4786, Currency Transaction Report, when the transaction amount equals or exceeds $10,000. This is generally referred to as Dollar Threshold Reporting. The Act also requires financial institutions to report suspicious transactions on Form TD F90-22.56, Suspicious Activity Report, to the Treasury Department, referred to as Suspicious Activity Reporting.

Various systems have been developed to report suspicious activity to the Treasury Department, incorporating a variety of implementation from manual and automated approaches. However, a shortcoming of many of the prior approaches is that they do not integrate the analysis of different types of financial transactions (such as money orders, wire transfers, etc.) that may occur within the same organization but still be subject to the BSA. Likewise, many of the systems do not provide for an automated means of assessing suspicious transactions from a collection of financial records transactions, nor do they provide for the assignment and monitoring of employee compliance to BSA regulations and internal financial organization policies. What is needed is an automated means of processing financial data to identify suspicious transactions. What is also needed is a means to assign and manage a manual review of transactions to employees through an automated method, and to enable distribution of review information through and automated technique. What is also needed is a means to monitor and enforce employee compliance with federal anti-money laundering laws and organization policy. What is also needed is a means to automatically monitor financial transactions with a collection of specified criteria and send immediate real-time feedback and disabling (lockout) information to terminals where such transactions originate.

Additional objects and advantages of the invention will be set forth in part in the description that follows, and in part will be obvious from the description, or may be learned by practice of the invention. The objects and advantages of the invention will be realized and attained by means of the elements and combinations particularly pointed out in the appended claims. It is to be understood that both the foregoing general description and the following detailed description are exemplary and explanatory only and are not restrictive of the invention, as claimed. Thus, the present invention comprises a combination of features, steps, and advantages that enable it to overcome various deficiencies of the prior art. The various characteristics described above, as well as other features, will be readily apparent to those skilled in the art upon reading the following detailed description of the preferred embodiments of the invention, and by referring to the accompanying drawings.

### BRIEF DESCRIPTION OF THE DRAWINGS

For a more detailed description of a preferred embodiment of the present invention, reference will now be made to the accompanying drawings, which form a part of the specification, and wherein:

FIG. 1 depicts a system-level view of one embodiment of the present invention;

FIG. 2 illustrates a flow chart describing an embodiment of the method of the present invention;

FIG. 3 illustrates a flow chart describing a second embodiment of the method of the present invention;

FIG. 4 illustrates a flow chart describing a third embodiment of the method of the present invention; and

FIG. 5 illustrates a flow chart describing a fourth embodiment of the method of the present invention.

### DETAILED DESCRIPTION OF THE PREFERRED EMBODIMENT

Reference will now be made in detail to exemplary embodiments of the invention, examples of which are illustrated in the accompanying drawings. Wherever possible, the same reference numbers will be used throughout the drawings to refer to the same or like parts.

The U.S. Postal Service (USPS) is designated as a financial institution under the Act. This is so because the USPS plays a role in transmitting funds from one party to another as it sells money orders and funds transfers. In order to comply with the recording and reporting requirements of the Act, the USPS has developed an integrated automated method. This method allows the USPS (1) to monitor USPS employee compliance with Dollar Threshold Reporting, and (2) to detect money laundering schemes and suspicious transactions. This method is not limited to USPS-sponsored transactions only. It is versatile and applicable to all financial institutions, and it could be utilized by such non-governmental entities to report those transactions needed for BSA compliance.

### Dollar Threshold Reporting

Form 8105-A is a USPS form on which postal employees report and document transactions totaling a dollar value amount of $3,000 or more. The $3,000 threshold applies to sales of financial instruments such as money orders and international funds transfers to the same customer on the same day. Dinero Seguro® is an international funds transfer system by which money is wired between the U.S. and Mexico through the USPS. This is a ‘Point of Sale’ dollar threshold requirement, and applies whether the transactions are suspicious or not. The law requires the collection of identifying information (Name, Address, ID Number, Social Security Number, and Date of Birth) from the customer who purchases financial instruments totaling $3,000 or more. The law also requires the selling entity to ‘maintain’ the identifying information and make it available to the Department of the Treasury upon request. When transactions total $10,000 or more, the identifying information (Name, Address, etc.) must be reported to the Department of the Treasury (not just maintained by the selling entity).

Data from transactions and from Forms 8105-A are entered into the BSA system for subsequent analysis and reporting. The data is stored in a database, accessible to any user of the BSA system. The system automatically reports 8105-A data for transactions totaling $10,000 to the Department of the Treasury. The system also accommodates analysis of 8105-A data to monitor employee compliance, as discussed in more depth below.

USPS employees have been trained to detect suspicious purchases of money orders at post offices. When they believe money order purchases are suspicious, employees are required to complete postal Form 8105-B, Suspicious Transaction Report. The postal employee also mails the form to a central location. Data from all Forms 8105-B are entered into the BSA system for further analysis.

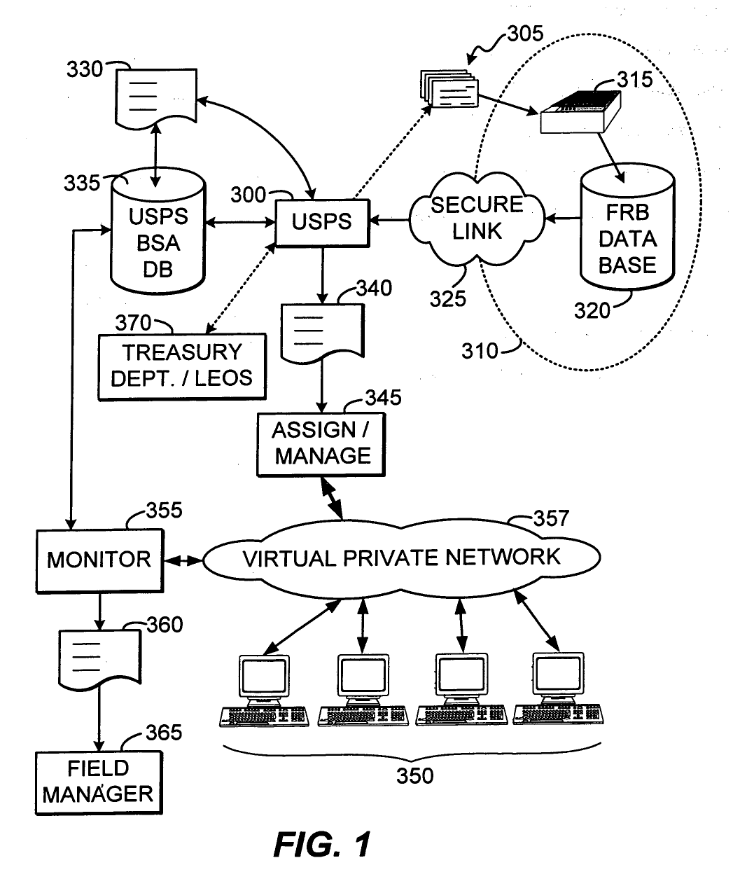

FIG. 1 depicts a system-level view of one embodiment of the present invention. Money orders or other financial instruments (305) are sold by the USPS or other financial organization (300), and relevant information such as sales data, Form 8105-A Data or Form 8105-B information (330) is stored in a BSA system database (335) used by the USPS (300). Persons of skill in the art appreciate that the database (335) may be a single database entity or may be a series of databases accessible through the BSA system. All postal money orders (305) sold by USPS or an analogous financial organization (300) are cleared through a Federal Reserve Bank such as the St. Louis Federal Reserve Bank (FRB) (310) or other clearing entities. The FRB (310) optically scans and captures (315) digitized images and textual information of the money orders it processes (305), and stores the digitized images and textual information in a secure database (320) accessible only to the FRB and USPS through a secure link (325). Based on analysis of the data obtained from the FRB (310) by the USPS (300) a request may be issued to review certain transactions or money order images, and the images and requests, and financial information (340) forwarded to a task assignment and management function (345). This function (345) is an automated and manual process for assigning the review of financial information (340) to a plurality of reviewer workstations (350) that may be distributed across a wide area through a secure link such as a virtual private network (357). The assignment of work tasks to workstations (350) can occur in real time and the assignment function assists in balancing the workload among the several workstations (350), and the images and data to be transmitted to the workstations may be sorted by office of issue to assist with the analysis. Workstations (350) are configured with software to enhance the review of document images by providing functions such as zoom in/zoom out, or improving resolution through visual manipulations such as changing the shading, contrast, or inverting the images. A monitoring function (355) reviews employee efficiency and quality performance of the reviewer workstations (350) or may review results of the workstation analysis to determine whether employees at the USPS (300) failed to properly document transactions involving money orders or other transactions (305). Among other things, the monitor (355) can generate reports or action requests (360), and forward them to enforcement functions such as a field manager (365). Suspicious transactions, or other reporting information is relayed by the USPS (300) directly to the U.S. Department of the Treasury (370). Likewise, law enforcement officers (LEOS) (370) may gain access to information at the USPS (300) through controlled access to information stored within the BSA database system (335).

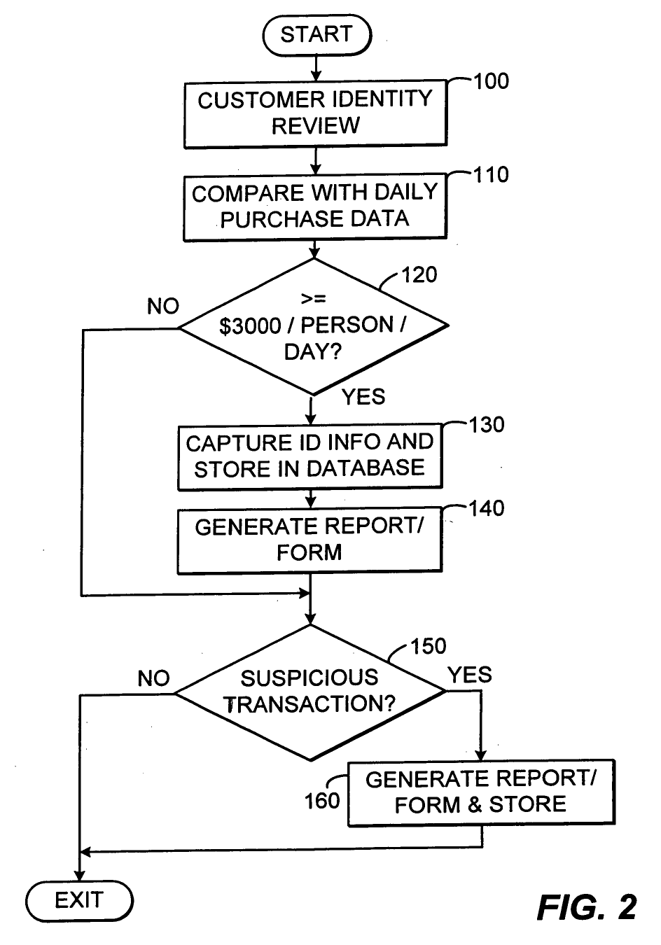

Turning now to FIG. 2, one aspect Dollar Threshold Reporting for the present invention is illustrated. The method begins with customer identification being collected or reviewed for a particular transaction (100). Such identification could be as simple as an employee visually recognizing a particular person as the same person who performed a previous transaction, or alternatively, by reviewing the person's identifying documentation. Then the current purchase transaction is compared (110) to previous transactions for the same customer, either through comparing to previous transactions on the same day as stored in a database such as the BSA database (FIG. 1, 335), or through manually comparing documents created on the same day, or by some combination of the two approaches. If the total value of such transactions from the comparison (110) meet or exceed a total dollar value threshold amount, say $3000, for that customer on the same day (120), then the customer's identifying information is captured (130) and a form and/or report is generated (140) such as a USPS Form 8105-A. Regardless of whether the information was captured and a form generated through steps. (130) and (140), the transaction is scrutinized (150) to determine whether it meets conditions that indicate a suspicious transaction. Such suspicious conditions surrounding the transaction may include, but are not limited to: (a) the same individual(s) who come in to post office on a regular frequency (e.g. daily, every other day, weekly) and purchase money orders totaling less than a total dollar value threshold amount such as $3,000, (b) two or more individuals working together to purchase money orders totaling less than a total dollar value threshold amount such as $3,000, or (c) individual(s) who ask for lesser aggregate amount of money orders when advised that they must complete a form such as form 8105-A when their daily purchase of money orders would total a dollar threshold amount such as $3,000 or more. If the transaction is considered suspicious, a form such as USPS form 8102-B is generated (160) and the data stored in a record in a database such as the BSA database (335) for reporting to the Treasury Department (370). If the total daily transaction amount for a particular customer exceeds a second total dollar threshold, it is reported to the Department of the Treasury as described below.

In addition to monitoring compliance with Dollar Threshold Reporting for money order transactions, the BSA system generates an automated Form 8105-A for international funds transfer (Diners Seguro® transactions). The process involves “tracking” international funds transfers by the same individual on the same business day. As an international funds transfer transaction is conducted, the sender's name and zip code for the current transaction are matched with senders' names and zip codes for previous transactions on the same day from the BSA database (335). When transaction totals for the same individual reach the total dollar threshold for the completion of Form 8105-A (e.g., $3,000), the form is automatically generated from the data provided in the transactions. This eliminates the need for employees to manually complete Forms 8105-A for applicable international funds transfer transactions. The resulting data is then stored in the BSA database (335) and is available for further analysis and comparison to other transactions.

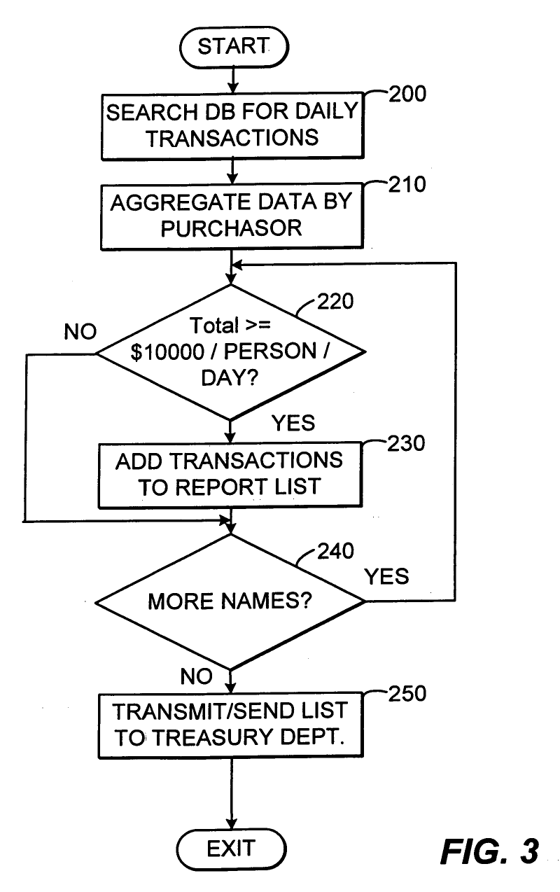

Turning now to FIG. 3, another aspect Dollar Threshold Reporting for the present invention is illustrated. In this embodiment, all records for a particular day's transactions that are stored in the BSA database (335) are searched (200) and records aggregated (210) by customer identifying information such as the customer's name and/or social security number. Each of these collections of records by client by date of transaction are summed to determine whether the total dollar value of a customer's total purchases of financial transactions meets or exceeds a total dollar threshold, such as $10,000 on a particular day (220). If the threshold is met or exceeded, a record of these transactions is created and added to a file or list (230) for reporting to a controlling entity such as the Treasury Department. If the threshold is not met or exceeded, in step (220) the process skips the adding names step (230). The process continues to the next customer transaction aggregation (240), if there are additional customers to process. Otherwise, the complete list of transactions that exceeded the threshold from step (220) are reported (250) to the Treasury Department (370) either through an automated transmission, delivery of a storage medium containing the list (such as a floppy diskette) or through a printed document.

### Non Compliance

The present invention provides a mechanism to monitor employee compliance with Dollar Threshold Reporting by analyzing money order sales data. The analysis involves the automated review of sequentially numbered money orders sold on the same day and at the same office to identify purchase patterns that would indicate that Form 8105-A should have been completed. Money order serial numbers identified in this process are matched with serial numbers reported on Forms 8105-A.

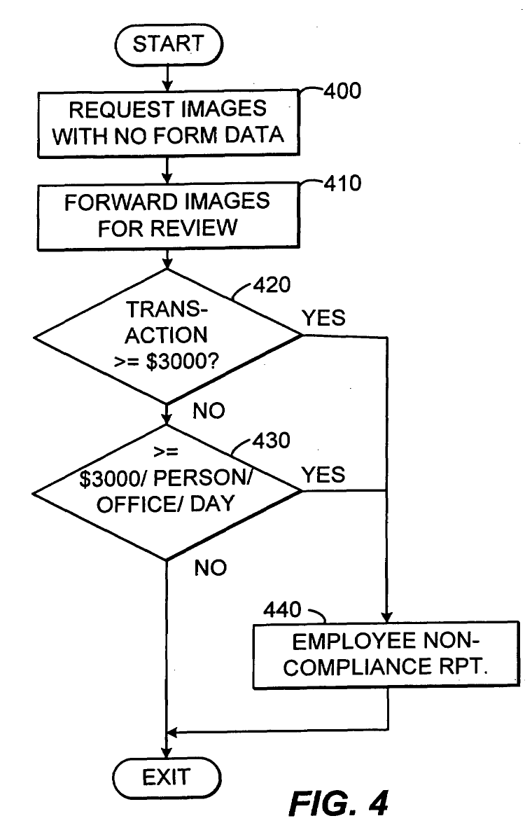

By providing a means to automate and manage the process of reviewing these images, one embodiment of the present invention illustrated in FIG. 4 allows for the monitoring and enforcement of employee compliance with the BSA and internal USPS procedures. Digitized imaged copies of money orders for which no Form 8105-A is on file are requested (400) from the FRB image archives (320). The imaged copies are forwarded and reviewed (410) by an entity such as one of the review workstations (350) to confirm whether or not reporting on a form such as Form 8105-A was required. If review discloses that a Form 8105-A was required by criteria such as the dollar value of the transaction itself being greater than or equal to a total dollar threshold amount such as $3000 (420) or if several images originate from the same post office for the same customer on the same day, and the total dollar values equal or exceed a threshold value such as $3000 (430) then the transaction is considered to be non-compliant with BSA dollar threshold reporting requirements. The BSA system generates reports (440) to field managers (365) advising them of noncompliance and encouraging them to initiate corrective action.

It will be appreciated that a system of monitoring employee compliance with the BSA reporting requirements significantly minimizes the risk of employee corruption or collusion with illegal transactions. A policy of supervising employee handling of financial transactions increases the likelihood of identifying those transactions that do fall within the BSA reporting requirement but failed to be reported. Thus non-performing individuals will be identified, and others will be encouraged to comply with the requirements.

Non-compliant transactions may be monitored monthly, quarterly, semi-annually, and annually for each post office to detect negative trends. Follow up noncompliance reports are sent to higher level managers as necessary to ensure that appropriate corrective action is taken.

### Suspicious Activity Reporting

The BSA requires the detection and reporting of suspicious activity at both the point of sale (for transactions totaling $2,000 or more) and during the review of financial instruments as they clear the banking system, what is commonly referred to as ‘back room analysis,’ (e.g., for transactions totaling $5,000 or more).

One embodiment of the present invention is designed to detect and deter the use of postal money orders and the international funds transfer product in money laundering schemes. The system analyses sales and encashment of postal money orders to detect suspicious transactions. In the case of international funds transfers, the system analyzes the pattern of usage. The analysis that the USPS system uses arises in the following context.

One embodiment of the present invention was developed to analyze cleared money orders to identify deposits that require analysis to determine whether they are suspicious. All USPS money orders (305) cleared by FRB (310) on a daily basis are analyzed at the FRB (310) for several possible events that may trigger the need for further analysis. One such triggering event is money orders (305) with face amounts equal to or greater than a certain dollar value that consecutively clear the FRB (310) on the same day (e.g., by passing through the FRB (310) Optical Character Reader (OCR) (315)) and have an aggregate total of some dollar threshold value such as $5,000 or more. Digitized images of those money orders identified by the triggering event are sent by the FRB (310) to the USPS (300) through a secure link (325) such as a secure FTP for further analysis. This process typically occurs daily, but those of skill in the art appreciate that it could occur with a different frequency.

The USPS (300) then analyzes through a series of workstations (350) the digitized images of the money orders (305) transmitted by the FRB (310) for several possible conditions that may indicate a possibility of money laundering activities. One such condition occurs when deposits of money orders or financial transactions were purchased at different post offices in the same general (or restricted) geographic area within the span of a few days. A second such condition occurs when multiple deposits of money orders bear similar handwriting were deposited into several bank accounts. A third such condition occurs when several money orders were deposited that bear no payees and/or endorsers. A person of skill in the art can appreciate that there may be other conditions that lead to suspicion of money laundering activities, all readily ascertainable by reviews of images of cleared money orders.

In addition to analyzing patterns of money orders clearing the FRB, the BSA system includes automated batch-mode analysis of financial transaction sales data stored in the BSA database (335). These batch-mode programs, run daily by the USPS (300), match financial transactions reported by employees at the point of sale and transactions identified as suspicious through analysis of sold transactions with transactions that have been identified at the FRB and entered into the database (335). Sales data is analyzed to detect patterns of transactions that meet certain criteria that indicate that the transactions have been purchased in a suspicious manner. One possible criterion for suspicion arises from multiple high-value (such as more than a few hundred dollars) consecutive purchases of transactions that total to reach or exceed a dollar threshold value (such as $2,000 or more).

All transactions identified as suspicious through the analysis are maintained in a comprehensive database such as the BSA database (335). All suspicious transactions in the database system (335) is reported to the Department of the Treasury (370) in accordance with federal money laundering laws and regulations. The data is also made available to the law enforcement community (370) through a series of on line interactive reports. Using queries, law enforcement agents can retrieve data in over 100 formats, and can direct data to external applications, such as Access, Excel, and via flat files, for use in any electronic medium.

### Dinero Seguro® Transactions

In addition to analyzing all postal money order activity, the present invention also provides a method to analyze all international funds transfer transactions that originated from the USPS (300) for suspicious activity. As an example, in the Dinero Seguro® service, the USPS (300) transmits funds directly to a Mexican bank. The present invention immediately stores information from funds transfer transactions in a system-wide database such as the BSA database (335). And real-time analysis of the funds transfer data such as matching senders, beneficiaries, identification numbers locations and dates of payout through the BSA database (335) may be used to detect possible suspicious activity. For example, if two or more individuals use the same identifications when purchasing international funds transfer transactions, the transactions are identified as suspicious.

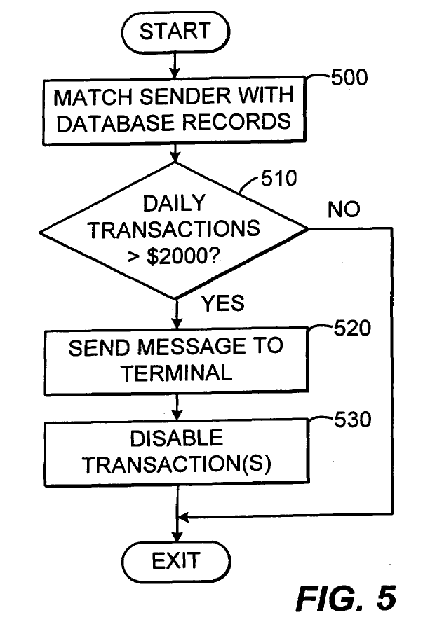

Analysis of international funds transfer transactions is performed in real-time for all transactions conducted anywhere in the U.S. during the same business day. As the flow chart in FIG. 5 illustrates, a transaction occurring at any USPS (300) office is matched (500) against all other financial transactions conducted at all USPS offices during the same business day. In one embodiment, the matching criteria is initially specified by the sender's name and zip code where the transaction originated, identifying a unique customer. If the analysis detects the same customer, and if international funds transfer transactions total in excess of a dollar threshold (such as $2,000) on the same day (510), a message is sent to the terminal where the transaction is taking place (520) advising the sales and service associate that the transaction exceeds the customer's daily limit. The transaction is disabled (530). Any subsequent transactions attempted on the same day are also disabled (530).

Likewise, the matching criteria referred to in the discussion above for FIG. 5. may comprise other data elements that are stored in the BSA database (335). Other data that may be searched includes the sender name, the payee or beneficiary, ID numbers, date of transaction, and payout dates. One type of search identifies those transactions with different senders but who used the same ID number, such as the person's driver's license number. Other criteria may also be utilized such as a search for a single sender who makes a certain number of transactions within a certain date range. This method may be employed, for example, to detect those who are attempting to avoid detection by transmitting funds below published threshold limits for suspicious activity. Modifications of that kind of search may include searches for numerous fund transfers going to the same recipient but from different senders within a certain date range. As with suspicious money order transactions, suspicious international funds transfer transactions are maintained in the database (335) for reporting to the Department of the Treasury (370) and available to the law enforcement community (370).

While preferred embodiments of this invention have been shown and described, modifications thereof can be made by one skilled in the art without departing from the spirit or teaching of this invention. The embodiments described herein are exemplary only and are not limiting. Many variations and modifications of the system and apparatus are possible and are within the scope of the invention. One of ordinary skill in the art will recognize that the process just described may easily have steps added, taken away, or modified without departing from the principles of the present invention. Accordingly, the scope of protection is not limited to the embodiments described herein, but is only limited by the claims that follow, the scope of which shall include all equivalents of the subject matter of the claims.

1-25. (canceled)

26. A method for analyzing financial instruments, comprising
transmitting the financial instruments to a clearing entity;
receiving digitized images of the financial instruments and instructions from the clearing entity;
determining if the instructions comprise a request for further review of the financial instruments;
if instructions comprise a request, assigning review of the digitized images to a reviewer workstation;
receiving analysis of the financial instruments from the reviewer workstation, the analysis comprising a determination of whether the financial instruments represent a plurality of consecutive high-value purchases that exceed a threshold amount; and
generating a report if the determination is positive.

27. The method of claim 26, wherein the analysis comprises a determination of whether the financial instruments originated from different financial institutions within the same geographic area.

28. The method of claim 26, wherein the analysis comprises a determination of whether a plurality of the financial instruments bear no payees.

29. The method of claim 26, wherein the analysis comprises a determination of whether the financial instruments bear no endorsers.

30. The method of claim 26, wherein the analysis comprises a determination of whether a plurality of the financial instruments bear similar handwriting but were deposited into more than one bank account.

31. The method of claim 26, wherein a purchaser of the financial instruments has the same identifying information.

32. The method of claim 31, wherein the analysis comprises a determination of whether the purchaser repeatedly purchased a plurality of the financial instruments.

33. A method for analyzing a purchase of a financial instrument, the method comprising:
obtaining identity information identifying a customer who is a purchaser of a first financial instrument;
detecting at least one second financial instrument purchased on the same day as the first financial instrument by a purchaser having the same identity information as the customer;
determining a total dollar value by adding a value of the first financial instrument to a sum of dollar values of the at least one second financial instrument;
storing the identity information if the total dollar value is equal to or above a first threshold amount; and
generating a report if the total dollar value is equal to or above a second threshold amount.

34. The method of claim 33, further comprising determining the first threshold amount based on a minimum dollar amount set by an Act of Congress.

35. The method of claim 33, further comprising determining the second threshold amount based on a minimum dollar amount set by an Act of Congress.

36. The method of claim 33, further comprising:
analyzing terms of the first financial instrument and the at least one second financial instrument, the analyzing comprising determining whether the first financial instrument and the at least one second financial instrument comprise terms that indicate money laundering activities;
generating a report if the total dollar value is equal to or above a third threshold amount and the determination is positive.

37. The method of claim 36, further comprising determining the third threshold amount based on a minimum dollar amount set by an Act of Congress.

38. The method of claim 33, wherein analyzing comprises determining whether the customer purchased the first financial instrument or the at least one second financial instrument for a dollar value that is less than the second threshold amount after the customer was informed that there is a requirement to complete a form reporting a purchase of a financial instrument if the dollar value of the financial instrument is over the second threshold amount.

39. The method of claim 33, wherein generating a report comprises:
storing a file having predefined fill fields;
merging the predefined fill fields with respective information about the customer and the terms of the first financial instrument.

40. A method for detecting suspicious transactions, the method comprising:
storing a file having predefined fill fields;
obtaining terms of a financial transaction, the terms comprising identity information identifying a first customer who is a purchaser of a financial instrument in the financial transaction;
comparing the terms of the financial transaction to a first criteria indicative of suspicious activities;
if the first criteria are satisfied, merging predefined fill fields with respective terms of the financial transaction; and
generating a report comprising the fill fields and the terms.

41. The method of claim 40, wherein the first criteria comprise criteria to determine if the customer repeatedly purchased a plurality of financial instruments.

42. The method of claim 40, wherein the first criteria comprise criteria to identify a second customer associated with the first customer to purchase a plurality of financial instruments, and a total dollar value of the plurality of financial instruments is greater than a threshold amount.
